(19) United States
(12) Patent Application Publication
(10) Pub. No.: US 2026/0194033 A1
(43) Pub. Date: Jul. 9, 2026

(54) High Pressure Fuel Pump With Configuration To Mitigate Cavitation

(71) Applicants: William de Ojeda, Darien, IL (US); Haibao Wu, Oakbrook Terrace, IL (US)

(72) Inventors: William de Ojeda, Darien, IL (US); Haibao Wu, Oakbrook Terrace, IL (US)

(21) Appl. No.: 19/014,685

(22) Filed: Jan. 9, 2025

(51) Int. Cl. F02M 37/00; F02M 59/46; F04B 13/00

(52) U.S. Cl. CPC F02M 37/0052; F02M 31/20; F02M 37/0029; F02M 37/043; F02M 59/46; F04B 11/00; F04B 23/021; F02M 37/0041; F04B 13/00; F04B 49/10

(57) ABSTRACT

A passage is placed in a high-pressure pump used with liquified gases such as Dimethyl Ether and propane to direct the inlet flow to either refill the plunger volume or to provide cooling around the plunger pumping unit. The passage is placed between the pump inlet metering valve volume and the pump return. The passage avoids fluid from stagnating and soaking up the heat from the pump. A spill check valve is used to control the flow through the spill port. The spill check valve opens to allow flow to cool the pump when the pump is pumping, and closes to direct fresh flow into the plunger cavity during refill. The cooling allows the high-pressure pump to operate at higher pressures while managing the heat and limiting the temperatures developed by the pumping, which otherwise would result in cavitation, loss of volumetric efficiency, and compromised operation due to excessive wear of the pump components exposed to cavitation.

### CROSS-REFERENCE TO RELATED APPLICATION

application Ser. No. #18/741,030

### STATEMENT OF FEDERALLY SPONSORED RESEARCH

This invention was made with government support under contract DE-EE0009878 awarded by the U.S. Department of Energy. The government has certain rights in the invention.

### NAMES OF THE PARTIES TO A JOINT RESEARCH AGREEMENT

Not applicable

### BACKGROUND OF THE INVENTION

Pressurization of a fluid raises the fluid temperature and the temperature of the pump components. In the case of pressurization of liquified gases such as Dimethyl Ether, propane, and similar fluids, heat from the pumping work will elevate the temperatures of the incoming fluid into the pump and risk flashing, with significant deterioration to the pumping efficiency. As the incoming fluid comes in contact with the hot environment, the fluid can transition from liquid to the vapor phase, thus cavitating.

If the fluid were to cavitate at the pump inlet, the pump's volumetric efficiency would drop dramatically generating severe ping-like noises and pump components would be subject to erosion over time, compromising the pump's function. Heating of the pump and the fluid in the pump limits the pump's pressure capability due to the onset of cavitation.

Several options exist to mitigate cavitation. One option is to increase the inlet pressure to shift the vapor pressure-temperature point to a higher value. A second option is to provide active cooling at the pump. The first option is inadequate because it places an excessive requirement on the feed pump used to prime the high-pressure pump. Pressures would need to increase considerably to avoid cavitation. Yet, higher pressures would further elevate the fluid temperatures. Real-life practice indicates that higher inlet pressures are not an effective way to reduce cavitation. The second option, applying active cooling, poses significant design challenges. One challenge is to place cooling passages near where the pump pressurizes the flow, near the plunger-barrel interface, corresponding to the most stressed parts of the pump. Furthermore, convection cooling is not effective in reducing temperatures near the plunger element of the pump.

Our invention provides a method to manage the inlet fluid temperature by (i) using excess inlet flow to cool the pump, and (ii) coordinating the excess flow with the inlet flow control valve open and close schedules. This invention does not require an increase in inlet pressure nor the design of complicated cooling passages in the pump. The invention can increase the pump pressure output with liquified gases.

### SUMMARY OF THE INVENTION

Our invention discloses a cooling methodology for a high-pressure fuel pump used with liquified gases, such as Dimethyl Ether and propane. High-pressure fuel pumps used with liquified gases are known to cavitate as the pressure output is increased, owing to the heat generated and the effect it has in raising the temperature of the inlet flow into the pump. As the pump temperature rises, the inlet flow temperature also rises over the saturation vapor pressure-temperature line, causing the fluid to vaporize. A high-temperature spot within the pump is sufficient to cause local cavitation, resulting in a rapid and severe deterioration of the pump's performance. Furthermore, any cavitation will compromise the pump's integrity, owing to premature wear of components.

In a typical common rail fuel injection system, such as in the invention disclosure U.S. Pat. No. 6,357,421-B1, the high-pressure fuel pump is fed at a fixed pressure, which ensures sufficient flow for optimum refill of the pump plungers, while not compromising the pump internal seals. Excess pressure is, for this reason, not desirable. For traditional fuels such as diesel, high temperatures developed at the pump during pressurization do not affect the density of the inlet flow. The high-pressure pump pressurizes the fluid at pressures for the injector to meter the fluid in the combustion chambers of the engine. The pressure is regulated at the common rail, by spilling excess flow to the tank. In this embodiment, the pump operates at full displacement and generates heat that is proportional to the amount of flow being pressurized.

The common rail design evolved to place metering valves in the high-pressure pump to limit the flow and limit the work needed to drive the pump, with the result of better engine efficiencies and lower pump temperatures. The inlet metering could take place at each of the pump's plunger units, such as in the patent disclosure U.S. Pat. No. 7,350,505-B2, or at the pump's overall inlet, with one valve metering the flow to multiple pump plungers, such as in the patent disclosure US 2009/0299606 A1. These later designs continue to use a pressure regulator in the rail for improved pressure regulation and management of fuel temperature in the rail.

Patent US-2016/0281661-A1 describes a pumping unit designed to feed diesel fuel from a storage tank to an internal combustion engine. The pumping unit includes a high-pressure piston pump and a low-pressure gear pump. The hydraulic circuit comprises multiple branches for fuel flow and lubrication. The circuit connects the storage tank, pre-feed pump, and high-pressure pump. It includes filtering devices to ensure clean fuel reaches the engine. Fuel leaks from the lubrication circuit are redirected back to the storage tank. The design prevents solid particles in the fuel from causing wear on components. Unlike the US-2016/0281661-A1 patent, which uses filtered fuel from the hydraulic circuit to lubricate portions of the transmission shaft in the pre-feed pump, our invention provides an additional return passage starting at the metering valve location which feeds the pump plunger. The return passage is placed at each plunger's inlet metering valve, allowing the flow to dissipate heat from this location. Each leakage path, one per plunger, accesses a volume of fuel designed into the inlet metering valve. Each volume and passage are positioned next to the pumping cavity. In addition, our invention places a check valve in the return passage that opens when the pump plunger is pumping, thus allowing excess flow to cool the pump, and closes when the plunger is intaking fuel, thus maximizing the refilling process with fresh flow, which further contributes to the pump cooling.

Patent US-2008/0156295-A1 discusses a fuel feed apparatus for accumulator fuel injection systems in internal combustion engines. The patent discloses a fuel feed apparatus that supplies high-pressure fuel to a common rail in an accumulator fuel injection system. It includes a high-pressure pump, feed pump, and fuel filter. The disclosure highlights a return passage to return fuel from downstream to upstream of the feed pump, with a return flow control unit regulating the flow of returning fuel. Conventional systems face issues with pressure loss and component wear in feed pumps. The invention aims to reduce pressure loss without enlarging the apparatus size. By returning fuel to the feed pump instead of the fuel tank, the system reduces fuel vapor production and improves fuel efficiency. The vent valve ensures that any accumulated gas is released, preventing disruptions in fuel flow. Unlike the US-2008/0156295-A1 patent, which describes the return flow near the feed pump, our invention describes a return passage at each inlet metering valve feeding the pump's plungers. A combination of a vent orifice and a check valve placed in the return passage allows for metering of the flow returning from the inlet metering valve body in a specific sequence. It opens when high pressure fuel is pumped, and it closes when the pump is intaking fresh fuel. Furthermore, unlike the US-2008/0156295-A1 patent which uses one metering valve upstream of all unit plungers and with no impact over the temperature conditions near the pumping cavities, our invention places a return passage at each pumping cavity to control temperature.

U.S. Pat. No. 7,793,642-B2 discloses a fuel supply apparatus to enhance fuel delivery efficiency and prevent clogging in internal combustion engines. It includes a fuel pump, filter unit, jet pump, and an introducing passage. The fuel pump draws fuel from a tank and supplies it to a high-pressure fuel system. The filter unit removes foreign matter from the fuel before it reaches the high-pressure system. The jet pump injects fuel to create a negative pressure, enhancing fuel flow. The objective is to maintain positive pressure on the inlet side of the fuel filter. The design aims to avoid wax clogging in the fuel filter during low-temperature conditions. Contrasting with U.S. Pat. No. 7,793,642-B2 patent, which describes a jet pump injecting fuel to maintain positive pressure on the inlet side of the fuel filter, our invention describes a return passage from the inlet metering valve which feeds the high-pressure pump plunger. U.S. Pat. No. 7,793,642-B2 places one inlet metering valve to control the flow of the high-pressure pump, regardless of the number of plungers, with no impact over the temperature conditions of the fluid near the pumping cavities. On the other hand, our invention places an inlet metering valve at each plunger, and a return passage from each inlet metering valve to the tank. Each return passage features a check valve. The check valve open and close positions depend on the inlet metering valve schedule. The check valve opens when the inlet metering valve is closed and the pump plunger is pumping. The check valve is closed when the inlet metering valve is open and plunger is intaking fuel.

In prior art of high-pressure fuel pump designs, elevated pump temperatures result near the plunger pumping element, high enough, that when pumping liquified gases temperatures will result in cavitation of the fluid at the inlet. In prior art, when the pump pressurizes the fluid, the inlet flow comes to a stop at the pump plunger inlet. The flow remains static during pressurization. The static flow is exposed to the high temperatures surrounding the plunger-barrel. This high temperature can bring the inlet flow to flash, whereupon the pump efficiency is compromised.

Our invention provides steps to manage the pump temperature and operate below the cavitation threshold at higher operating pressures. It provides a passage with a check valve from the inlet metering valve feeding the pump plunger cavity to the pump return to the tank. The check valve is open and allows a cooling flow to the barrel when the inlet metering valve is closed and the plunger is pumping. On the other hand, the check valve is closed when the inlet metering valve is open and the plunger is retraction to refill, thus providing fresh flow into the plunger volume.

### BRIEF DESCRIPTION OF THE DRAWINGS

An exemplary embodiment of this invention is represented in the drawings and is explained in more detail in the following description.

FIG. 1 shows the configuration of a common rail system, with notable placement of the high-pressure fuel pump and how the flow is introduced therein in the present state of art.

FIG. 2 shows a modification of the current state of art of the common rail system, showing the cooling port and the placement of the spill valve.

FIG. 3 shows a rendering of the plunger motion, flow into the high-pressure rail, and the operation schedule of the inlet metering valve.

FIG. 4 shows the high-pressure pump, highlighting the pump refill, with the inlet metering valve in the open position, and the spill check valve closed.

FIG. 5 shows the high-pressure pump, highlighting the pump refill, with the inlet metering valve in the open position, and the output check valve closed.

FIG. 6 shows the flow pattern during the refill in a view showing the spill check valve.

FIG. 7 shows the flow pattern during the refill in a view showing the output check valve.

FIG. 8 shows the flow pattern during the pumping stroke in a view showing the spill check valve.

FIG. 9 shows the flow pattern during the pumping stroke in a view showing the output check valve.

### DETAILED DESCRIPTION

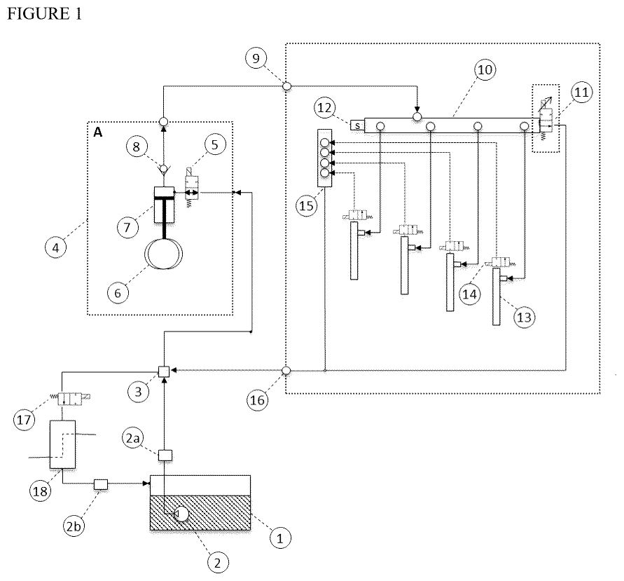

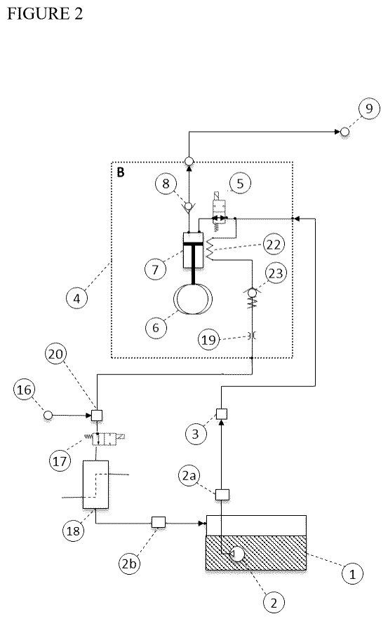

FIG. 1 shows a common rail fuel injection system used in an engine. The illustration is used to highlight the invention later shown in FIG. 2. The system is comprised of a tank (1) to store fuel, and in the case of a liquified gas, the tank stores fuel in the liquid state at the bottom and gas on the top at the vapor saturation pressure. A fuel delivery pump (2), stored in or out of the tank, shown here inside the tank, pressurizes the fuel, and delivers it through a junction port (3) to a high-pressure fuel pump (4). When the fuel used is a liquified gas, and the tanks is at pressure above atmospheric, shutoff valves are used at the tank outlet (2a) and return (2b), to isolate the tank when the engine is shut down. For a liquified gas system, the feed to the high-pressure pump remains in the liquid state. A low-pressure regulating valve (17) is used to control the feed pressure.

The high-pressure pump (4) is comprised of an inlet metering valve (5), a crank (6), shown here with two lobes to displace a plunger (7) with each revolution, and an output check valve (8). The pump may have one or more plungers. The inlet metering valve (5) is electronically controlled to fill the plunger (7). Timing allows fuel to return to the inlet before it closes to match the fuel demand by the injectors. The high-pressure output flow is directed via port (9) to the fuel rail (10). The rail (10) houses a fuel pressure regulator (11) and a fuel pressure sensor (12). The rail (10) provides a stable pressure and flow to the injectors (13), which vary in number according to the engine configuration. The injector (13) meters flow into the engine cylinder via its electronic metering valve (14), which, upon actuation, spills flow to the injector return manifold (15). Flow from the return manifold (15) and from the pressure regulator (11) spill, is directed through port (16) to the junction (3). The return flow is directed through the pressure regulating valve (17), to a heat exchanger (18), and back to the tank (1). The heat exchanger (18) dissipates heat built up by pumping and from the engine combustion through the block to the rail. In this embodiment, the flow into the pump is fully exposed to the heat absorbed by the pump due to the pumping work.

FIG. 2 shows a variation of the embodiment found in FIG. 1 and describes the invention. Here, the flow from the low-pressure pump (2) is directed through the isolation valve (2a) and junction (3) into the high-pressure pump (4). Flow is favored to feed directly through the inlet metering valve (5) into the pumping plunger (7). Inlet flow is directed to a cooling passage (22) and through a lightly spring-loaded spill check valve (23) when the inlet metering valve (5) is closed. When the inlet metering valve (5) is open, the spill check valve (23) is closed, allowing the fuel supply to enter the plunger at a temperature level close to the tank fuel temperature. Additional flow metering control can be established by the orifice passage (19). The orifice (19) can be sized to control the fluid residence time in the barrel to optimize the heat transfer. From passage (19) flow is directed through the junction (20), to the low-pressure regulator (17), into the heat exchanger (18), through the isolation valve (2b), back to the tank (1). Return from the fuel rail pressure relief valve (11) and the injector spill valves (14), is routed through port (16) into the junction (20).

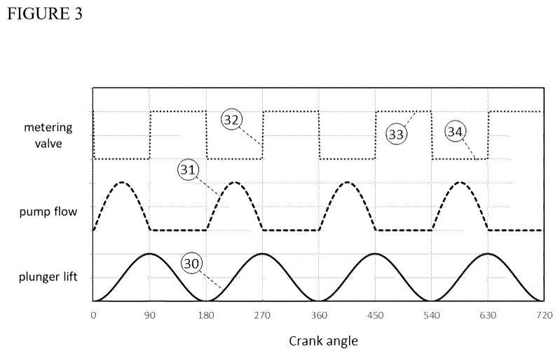

FIG. 3 shows a representation of the pumping plunger motion (30) driven by the pump crank. The pump flow (31) is illustrated corresponding to the inlet metering valve schedule (32). FIG. 3 indicates segment (33) where the inlet metering valve is open, corresponding to the filling of the plunger, as the plunger is retracted back to the base circle of the crank. FIG. 3 indicates segment (34) where the inlet metering valve is closed as the plunger pumps fluid into the rail. During segment (34), the inlet metering valve (5) is closed, and fuel in the embodiment of FIG. 1 is stationary and it is heated by the pump housing. In the embodiment of FIG. 2, the inlet fluid flows through the pump cooling passage (22) where the fuel absorbs heat from the pump and returns it to the tank (1) via the spill check valve (23), regulator (17), and heat exchanger (18). The flow during segment (34) serves to cool the pump inlet to the plunger.

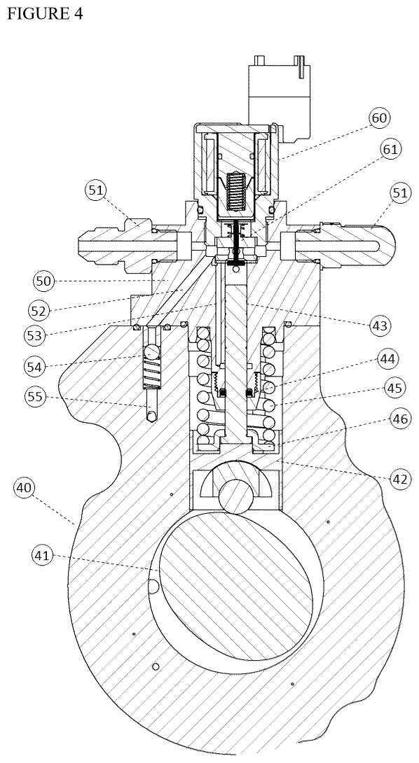

FIG. 4 shows a cutaway of the high-pressure pump, housing (40), crank (41), roller follower (42), plunger (43), plunger cap-seal arrangement (44), plunger spring (45), and plunger foot (46). The pump barrel (50) provides features for the fuel inlet by means of fittings (51), a primary spill passage (52) communicating the inlet feed to the pump return, and a secondary spill passage (53) communicating the leakage arising from the plunger-to-barrel clearance to the primary spill passage (52). The spill from the primary spill passage (52) is directed through a check valve (54) to the pump return (55).

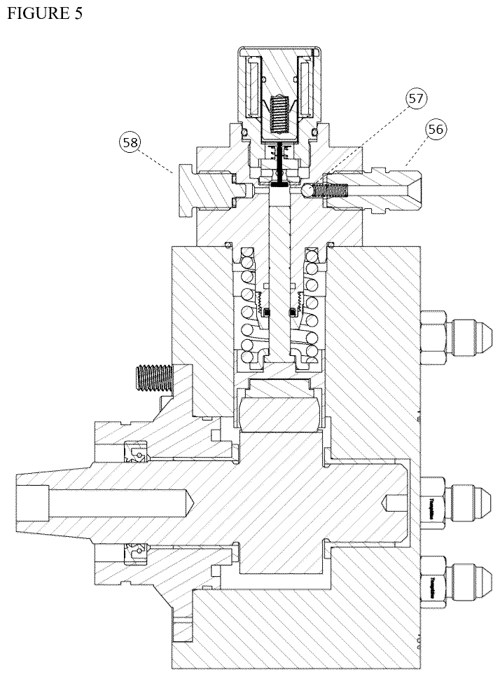

FIG. 5 shows a cutaway of the high-pressure pump, highlighting the outlet check valve (57), constrained in place by the outlet fitting (56). The check valve can be placed in one direction or another, alternating its position with the seal plug (58).

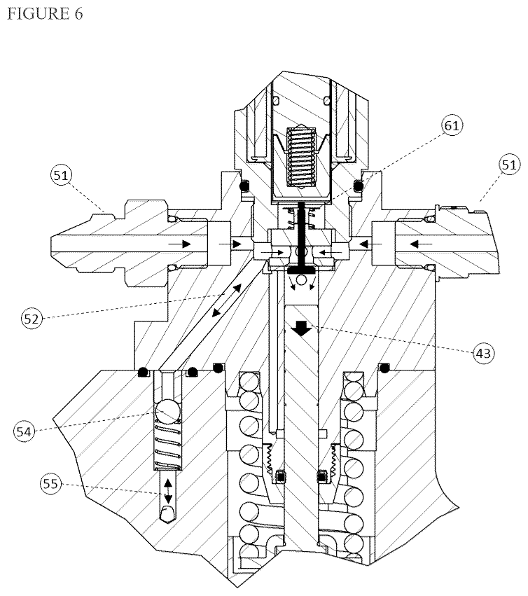

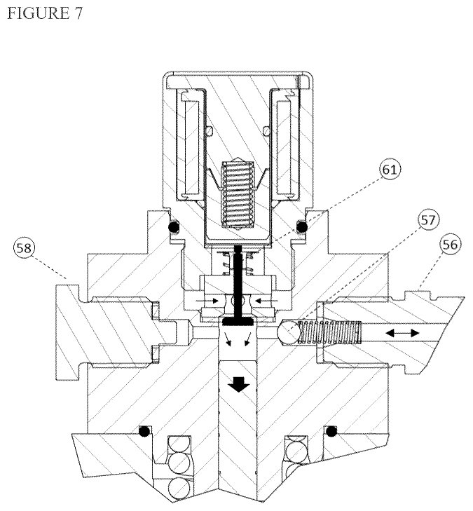

FIG. 6 is a detailed view of FIG. 4, showing the plunger (43) motion in the refill configuration. Fuel is drawn from the inlet via the fittings (51). The inlet metering valve stem (61) is in the open position with the solenoid de-energized. The combination of the fuel depression produced by the expanded plunger volume and the spring loading of the spill check valve (54), causes the spill check valve (54) to close. This arrangement results in the inlet flow being routed to the plunger. The inlet flow to the plunger is at a temperature near the supply source and lower than the barrel temperature. FIG. 7, corresponding to the same inlet metering valve (61) open configuration, shows the outlet check valve (57) in the closed position. In the refill configuration, the flow is at a standstill in the spill passage (52) and at the outlet fitting (56).

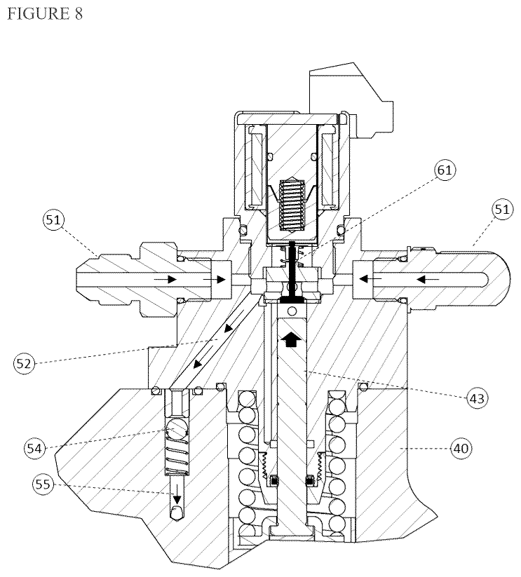

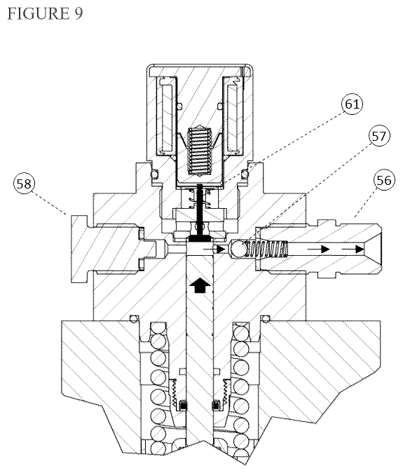

FIG. 8 shows the pumping event as the plunger (43) moves towards the top dead center position. During the pumping event, the solenoid is energized, resulting in the inlet metering valve (61) moving to its closed position under the force of the valve spring and high pressure within the plunger cavity. With the inlet metering valve (61) closed, the inlet flow is directed through the spill passage (52), into the spill check valve (54), into the pump return passage (55). The spill flow allows for the inlet flow to soak heat from the plunger (43) and barrel housing (40). FIG. 9, corresponding to the same inlet metering valve (61) closed configuration, shows the outlet check valve (57) in the open condition. The fuel is directed to the rail.

What is claimed is:

1. A fluid pumping flow control device designed for use in a high-pressure fluid system, operating between 200 bar and 3000 bar pressure, and comprising:
a device body with a cavity and a high-pressure circuit;
a plunger placed in the specified cavity designed for reciprocal motion;
a cap at the end of the device body;
a seal installed between the cap and the body;
an inlet metering device communicating the supply pressure to the plunger pressure cavity;
a volume around the inlet metering valve ranging from 5 to 20 times the volume displaced by the plunger;
a communication passage extending from the inlet metering volume to the fuel side of the seal;
a spill passage extending from the inlet metering volume to the pump tank port; and,
a spring-loaded spill check valve located in the spill passage from the inlet metering volume to the tank;
wherein the flow through the spill check valve depends on the positioning of the inlet metering valve and plunger motion;
wherein the flow through the spill check valve takes place when the inlet metering valve is closed;
wherein the flow through the spill check valve is suppressed when the inlet metering valve is open, and the plunger is refilling;
wherein the fuel is never at a standstill in the inlet volume to the plunger.

2. The fluid flow control device of claim 1, wherein the pressure in the inlet metering valve volume and spill passage is the same as the supply pressure when the inlet metering valve is closed.

3. The fluid flow control device of claim 1, wherein the flow through the spill check valve when the inlet metering valve is closed, is dependent on the pressure differential between the supply pressure and the return pump pressure, check valve area, and check valve spring preload.

4. The fluid flow control device of claim 1, wherein the pressure in the inlet metering valve volume and spill passage is lower than the supply pressure when the inlet metering valve is open, and the plunger is refilling.

5. The fluid flow control device of claim 1, wherein the flow through the spill check valve when the inlet metering valve is open, is zero.

6. The fluid flow control device of claim 1, wherein the spill passage is placed between the inlet metering volume and the fuel return outlet of the pump.

7. The fluid flow control device of claim 1, wherein a spill check valve is placed in the spill passage between the inlet metering volume and the fuel return outlet of the pump.

8. The fluid flow control device of claim 1, wherein a spill check valve spring preloaded force is lower than the force developed by the pressure differential between the supply and return pressures across the spill check valve area.

9. A fluid pumping flow control device designed for use in a high-pressure fluid system, operating between 200 bar and 3000 bar pressure, and comprising:
a device body with a cavity and a high-pressure circuit;
a plunger placed in the specified cavity designed for reciprocal motion;
a cap at the end of the device body;
a seal installed between the cap and the body;
an inlet metering device communicating the supply pressure to the plunger pressure cavity;
a volume around the inlet metering valve ranging from 5 to 20 times the volume displaced by the plunger;
a communication passage extending from the inlet metering volume to the fuel side of the seal;
a spill passage extending from the inlet metering volume to the pump tank port;
a spring-loaded spill check valve located in the spill passage from the inlet metering volume to the tank; and,
an orifice element located between the spill check valve and the tank;
wherein the position of the spill check valve depends on the positioning of the inlet metering valve and plunger motion, with the flow through the spill check valve controlled by the size of the orifice placed downstream for the spill check valve.

10. The fluid flow control device of claim 9, wherein the flow through the spill check valve when the inlet metering valve is closed, is dependent on the pressure differential between the supply pressure and the return pump pressure, check valve area, check valve spring preload, and the added restriction of the orifice element.
